(19) United States
(12) Patent Application Publication
(10) Pub. No.: US 2025/0115752 A1
(43) Pub. Date: Apr. 10, 2025

(54) THERMOPLASTIC ELASTOMER ARTICLES COMPRISING STYRENE BLOCK COPOLYMER

(71) Applicant: Avient Corporation, Avon Lake, OH (US)

(72) Inventors: Jiren Gu, Crystal Lake, IL (US); Hochul Jung, Algonquin, IL (US); John Swanson, Lakewood, OH (US)

(73) Assignee: Avient Corporation, Avon Lake, OH (US)

(21) Appl. No.: 18/726,340

(22) PCT Filed: Jan. 4, 2023
(86) PCT No.: PCT/US2023/010155

§ 371 Date: Jul. 2, 2024

Related U.S. Application Data
(60) Provisional application No. 63/296,647, filed on Jan. 5, 2022.

(51) Int. Cl. C08L 51/00; C08F 287/00; C08L 91/00

(52) U.S. Cl. CPC C08L 51/006; C08F 287/00; C08L 91/00; C08L 2205/03; C08L 2205/06; C08L 2207/04; C08L 2207/322

(57) ABSTRACT

Embodiments of the present disclosure are directed to thermoplastic elastomer articles comprising a crosslinked reaction product of styrene block copolymer and silane. The styrene block copolymer comprises at least one terminal polymer block A. The at least one terminal polymer block A comprises a vinyl compound having para-alkylstyrene. The styrene block copolymer is silane grafted and silane crosslinked.

### CLAIM OF PRIORITY

This application claims the benefit of U.S. Provisional Patent Application Ser. No. 63/296,647 bearing Attorney Docket Number 1202201 and filed on Jan. 5, 2022, which is hereby incorporated by reference in its entirety.

### TECHNICAL FIELD

Embodiments of the present disclosure are generally related to thermoplastic elastomer articles, and are specifically related to thermoplastic elastomer articles of styrene block copolymer having increased chemical resistance, heat resistance, and observable clarity.

### BACKGROUND

Thermoplastic elastomer articles may have desirable mechanical properties, such as tensile strength at break and tensile elongation at break. However, these articles may not have the chemical resistance (e.g., oil resistance), heat resistance, or observable clarity desirable for certain applications in the healthcare, automotive, and electronic fields.

Accordingly, a continual need exists for improved thermoplastic elastomer articles that have improved chemical resistance, heat resistance, and observable clarity for the aforementioned applications.

### SUMMARY

Embodiments of the present disclosure are directed to thermoplastic elastomer articles comprising a crosslinked reaction product of styrene block copolymer and silane, which have increased chemical resistance, heat resistance, and observable clarity.

According to one embodiment, a thermoplastic elastomer article is provided. The thermoplastic elastomer article comprises a crosslinked reaction product of styrene block copolymer and silane. The styrene block copolymer comprises at least one terminal polymer block A. The at least one terminal polymer block A comprises a vinyl compound having para-alkylstyrene. The styrene block copolymer is silane grafted and silane crosslinked.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of thermoplastic elastomer articles, specifically thermoplastic elastomer articles comprising the crosslinked reaction product of styrene block copolymer and silane. The styrene block copolymer comprises at least one terminal polymer block A. The at least one terminal polymer block A comprises a vinyl compound having para-alkylstyrene. The styrene block copolymer is silane grafted and silane crosslinked.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “wt %,” as described herein, refers to the weight fraction of the individual reactants of the formulation used to produce the crosslinked reaction product that comprises the thermoplastic elastomer article, unless otherwise noted. For simplicity purposes, “wt %” will be referred to throughout as the amount in the thermoplastic elastomer article.

The term “melt flow rate,” as described herein, refers to the ability of a material's melt to flow under pressure as measured according to ASTM D1238 at the given temperature and given weight.

The term “density,” as described herein, refers to the mass per unit volume of a material as measured according to ASTM D792 at 23° C.

The term “specific gravity,” as described herein, refers to the ratio of the density of a material to the density of water as measured according to ASTM D792 at 23° C.

The term “Mooney viscosity,” as described herein, refers to the viscosity reached after a rotor rotates for a given time interval at the specified temperature as measured according to ASTM D1646.

The term “yield,” as described herein, refers to the point on a stress-strain curve that indicates the limit of elastic behavior and the beginning of plastic behavior.

The term “tensile strength at yield,” as described herein, refers to the maximum stress that a material can withstand while being stretched before it begins to change shape permanently as measured according to ASTM D638 at 23° C. and a rate of strain of 0.85 mm/s.

The term “tensile elongation at yield,” as described herein, refers to the ratio between the increased length and initial length at the yield point as measured according to ASTM D638 at 23° C. and a rate of strain of 0.85 mm/s.

The term “tensile strength at break,” as described herein, refers to the maximum stress that a material can withstand while stretching before breaking as measured according to ASTM D638 at 23° C. and a rate of strain of 0.85 mm/s.

The term “tensile elongation at break,” as described herein, refers to the ratio between increased length and initial length after breakage as measured according to ASTM D638 at 23° C. and a rate of strain of 0.85 mm/s.

The term “Shore A hardness,” as described herein, refers to the hardness of a material as measured according to ASTM D2240.

The term “similar hardness,” as used herein refers to a hardness within 10 (i.e., ±10).

The terms “improved chemical and heat resistance” or “increased chemical and heat resistance,” as used herein, refers to a thermoplastic elastomer article as described herein having a reduced oil immersion weight increase and a reduced compression set as compared to a comparative thermoplastic elastomer article having a similar hardness.

The term “improved observable clarity” or “increased observable clarity,” as used herein, refers to a thermoplastic elastomer article as described herein having a translucent appearance as compared to a comparative thermoplastic elastomer article having a similar hardness and having an opaque appearance.

The term “compression set,” as described herein, refers to the ability of a material to return to its original thickness after prolonged compressive stress as measured according to ASTM D395 at the temperature indicated.

The term “boiling point,” as described herein, is measured using thermogravimetric analysis (TGA).

The term “silane grafted,” as described herein, refers to the styrene block copolymer having a silane side chain connected to the polymer main chain. The grafted silane allow the styrene block copolymer to silane crosslink.

The term “copolymer,” as described herein, refers to a polymer formed when two or more different monomers are linked in the same chain.

The term “block,” as described herein, refers to a portion of a macromolecule, comprising many constitutional units, that has at least one feature which is not present in the adjacent portions.

The term “olefin block copolymer (OBC),” as described herein, refers to a polymer comprising a plurality of blocks or segments, each comprising an ethylene or propylene repeating unit and an alpha-olefin repeating unit in different mole fractions.

The term “polyolefin,” as described herein, refers to a polymer has that has a crystalline and amorphous phase made from prepared from olefin monomers.

The term “polyolefin elastomer (POE),” as described herein, refers to a low crystalline (i.e., less than or equal to 25% crystalline) polymer prepared from olefin monomers

The term “ethylene alpha-olefin copolymer,” as described herein, refers to an ethylene alpha-olefin copolymer comprising C₃-C₁₂ olefins.

As discussed hereinabove, thermoplastic elastomer articles may have desirable mechanical properties, such as tensile strength at break and tensile elongation at break. However, these articles may not have the chemical resistance (e.g., oil resistance), heat resistance, or observable clarity desirable for certain applications in the healthcare, automotive, and electronic fields.

Disclosed herein are thermoplastic elastomer articles, which mitigate the aforementioned problems. Specifically, the thermoplastic elastomer articles disclosed herein comprise a crosslinked reaction product of styrene block copolymer and silane, which results in a chemical resistant, heat resistant, and translucent thermoplastic elastomer article. The styrene block copolymer comprises at least one terminal polymer block A. The at least one terminal polymer block A comprises a vinyl compound having para-alkylstyrene. The styrene block copolymer is silane grafted and silane crosslinked. This occurrence of silane crosslinking, along with the presence of the para-alkylstyrene, provides improved chemical resistance, heat resistance, and observable clarity.

Moreover, the present thermoplastic elastomer articles have increased crosslinking, as evidenced by reduced compression set, resulting from a moisture cure process as compared to a thermoplastic elastomer article that includes para-alkylstyrene block copolymer crosslinked via a peroxide cure process. A peroxide cure process is relatively rapid and may not result in sufficient crosslinking. With a moisture cure process, the process is relatively controlled and results in increased crosslinking, particularly at the at least one terminal polymer block A. Increased crosslinking may provide relatively higher levels of chemical and heat resistance.

The thermoplastic elastomer articles disclosed herein may generally be described as the crosslinked reaction product of styrene block copolymer and silane.

### Styrene Block Copolymer

The styrene block copolymer of the thermoplastic elastomer article comprises at least one terminal polymer block A. The at least one terminal polymer block A comprises a vinyl compound having para-alkylstyrene. As described hereinabove, the presence of the para-alkylstyrene, along with the occurrence of silane crosslinking, produces a thermoplastic elastomer article having improved chemical resistance, heat resistance, and observable clarity.

In embodiments, the para-alkyl styrene comprises para-methylstyrene. In embodiments, both terminal polymer blocks of the styrene block copolymer may be terminal polymer block A.

In embodiments, the styrene block copolymer may further comprise at least one interior polymer block B. The at least one interior polymer block B may comprise conjugated diene. In embodiments, the conjugated diene may comprise butadiene, isoprene, 2-3, dimethyl-1,3-butadiene, 1,3-pentadiene, 1,3-hexadiene, or a combination thereof. In embodiments, greater than or equal to 70% of the carbon-carbon double bonds of the polymer block B may be hydrogenated.

In embodiments, the styrene block copolymer may include one or more additional blocks comprising additional comonomers. In embodiments, the additional comonomers of the styrene block copolymer may comprise butadiene, isoprene, styrene-ethylene/butylene-styrene block copolymers (SEBS), styrene isoprene block copolymers (SIS), styrene-(ethylene/propylene)-styrene block copolymer (SEEPS), or a combination thereof.

In embodiments, the styrene block copolymer may be included in amounts greater than or equal to 20 wt %. In embodiments, the amount of the styrene block copolymer may be limited (e.g., less than or equal to 60 wt %). In embodiments, the amount of the styrene block copolymer in the thermoplastic elastomer article may be greater than or equal to 20 wt %, greater than or equal to 23 wt %, greater than or equal to 25 wt %, greater than or equal to 27 wt %, greater than or equal to 30 wt %, greater than or equal to 33 wt %, or even greater than or equal to 35 wt %. In embodiments, the amount of the styrene block copolymer in the thermoplastic elastomer article may be less than or equal to 60 wt %, less than or equal to 57 wt %, less than or equal to 55 wt %, less than or equal to 53 wt %, less than or equal to 50 wt %, less than or equal to 47 wt %, or even less than or equal to 45 wt %. In embodiments, the amount of the styrene block copolymer in the thermoplastic elastomer article may be from 20 wt % to 60 wt %, from 20 wt % to 57 wt %, from 20 wt % to 55 wt %, from 20 wt % to 53 wt %, from 20 wt % to 50 wt %, from 20 wt % to 47 wt %, from 20 wt % to 45 wt %, from 23 wt % to 60 wt %, from 23 wt % to 57 wt %, from 23 wt % to 55 wt %, from 23 wt % to 53 wt %, from 23 wt % to 50 wt %, from 23 wt % to 47 wt %, from 23 wt % to 45 wt %, from 25 wt % to 60 wt %, from 25 wt % to 57 wt %, from 25 wt % to 55 wt %, from 25 wt % to 53 wt %, from 25 wt % to 50 wt %, from 25 wt % to 47 wt %, from 25 wt % to 45 wt %, from 27 wt % to 60 wt %, from 27 wt % to 57 wt %, from 27 wt % to 55 wt %, from 27 wt % to 53 wt %, from 27 wt % to 50 wt %, from 27 wt % to 47 wt %, from 27 wt % to 45 wt %, from 30 wt % to 60 wt %, from 30 wt % to 57 wt %, from 30 wt % to 55 wt %, from 30 wt % to 53 wt %, from 30 wt % to 50 wt %, from 30 wt % to 47 wt %, from 30 wt % to 45 wt %, from 33 wt % to 60 wt %, from 33 wt % to 57 wt %, from 33 wt % to 55 wt %, from 33 wt % to 53 wt %, from 33 wt % to 50 wt %, from 33 wt % to 47 wt %, from 33 wt % to 45 wt %, from 35 wt % to 60 wt %, from 35 wt % to 57 wt %, from 35 wt % to 55 wt %, from 35 wt % to 53 wt %, from 35 wt % to 50 wt %, from 35 wt % to 47 wt %, or even from 35 wt % to 45 wt %, or any and all sub-ranges formed from any of these endpoints.

Suitable commercial embodiments of the para-alkylstyrene block copolymer may be available under the SEPTON brand from Kuraray, such as grade V9461 and grade V9475, as well as other para-alkylstyrene block polymers.

### Silane

As stated hereinabove, the styrene block copolymer is silane grafted and silane crosslinked. The occurrence of silane crosslinking results in a thermoplastic elastomer article having improved chemical resistance, heat resistance, and observable clarity.

Various silanes are considered suitable for the present thermoplastic elastomer articles. In embodiments, the silane may comprise vinyl trialkoxysilane. For example, in embodiments, the silane may comprise vinyl trimethoxysilane, vinyl triethoxysilane, or a combination thereof.

In embodiments, the silane is included in amounts greater than or equal to 0.5 wt % such that the styrene block copolymer is silane grafted and silane crosslinked to produce a thermoplastic elastomer article having improved chemical resistance, heat resistance, and observable clarity. In embodiments, the amount of silane may be limited (e.g., less than or equal to 5 wt %). In embodiments, the amount of silane in the thermoplastic elastomer article may be greater than or equal to 0.5 wt %, greater than or equal to 1 wt %, or even greater than or equal to 2 wt %. In embodiments, the amount of silane in the thermoplastic elastomer articles article may be less than or equal to 5 wt % or even less than or equal to 3 wt %. In embodiments, the amount of silane in the thermoplastic elastomer article may be from 0.5 wt % to 5 wt %, from 0.5 wt % to 3 wt %, from 1 wt % to 5 wt %, from 1 wt % to 3 wt %, from 2 wt % to 5 wt %, or even from 2 wt % to 3 wt %, or any and all sub-ranges formed from any of these endpoints.

In embodiments, the silane may have a specific gravity greater than or equal to 0.9 or even greater than or equal to 0.95. In embodiments, the silane may have a specific gravity less than or equal to 1.05 or even less than or equal to 1. In embodiments, the silane may have a specific gravity from 0.9 to 1.05, from 0.9 to 1, from 0.95 to 1.05, or even from 0.95 to 1, or any and all sub-ranges formed from any of these endpoints.

In embodiments, the silane may have a boiling point greater than or equal to 75° C. or even greater than or equal to 100° C. In embodiments, the silane may have a boiling point less than or equal to 150° C. or even less than or equal to 125° C. In embodiments, the silane may have a boiling point from 75° C. to 150° C., from 75° C. to 125° C., from 100° C. to 150° C., or even from 100° C. to 125° C., or any and all sub-ranges formed from any of these endpoints.

Suitable commercial embodiments of the silane are available under the SILQUEST brand from Momentive, such as grade A-171.

In embodiments, the silane may be included in a solution comprising organic peroxide such that the silane is better dispersed within the styrene block copolymer, leading to improved silane grafting and silane crosslinking. In embodiments, the organic peroxide may comprise dicumyl peroxide. In embodiments, the amount of organic peroxide in the thermoplastic elastomer article may be greater than or equal to 0.05 wt % or even greater than or equal to 0.1 wt %. In embodiments, the amount of organic peroxide in the thermoplastic elastomer article may be less than or equal to 1 wt % or even less than or equal to 0.5 wt %. In embodiments, the amount of organic peroxide in the thermoplastic elastomer article may be from 0.05 wt % to 1 wt %, from 0.05 wt % to 0.5 wt %, from 0.1 wt % to 1 wt %, or even from 0.1 wt % to 0.5 wt %, or any and all sub-ranges formed from any of these endpoints.

In embodiments, the organic peroxide may have a density greater than or equal to 1 g/cm³ or even greater than or equal to 1.05 g/cm³. In embodiments, the organic peroxide may have a density less than or equal to 1.2 g/cm³ or even less than or equal to 1.15 g/cm³. In embodiments, the organic peroxide may have a density from 1 g/cm³ to 1.2 g/cm³, from 1 g/cm³ to 1.15 g/cm³, from 1.05 g/cm³ to 1.2 g/cm³, or even from 1.05 g/cm³ to 1.15 g/cm³, or any and all sub-ranges formed from any of these endpoints.

In embodiments, the organic peroxide may have a boiling point greater than or equal to 75° C. or even greater than or equal to 100° C. In embodiments, the organic peroxide may have a boiling point less than or equal to 150° C. or even less than or equal to 125° C. In embodiments, the organic peroxide may have a boiling point from 75° C. to 150° C., from 75° C. to 125° C., from 100° C. to 150° C., or even from 100° C. to 125° C., or any and all sub-ranges formed from any of these endpoints.

Suitable commercial embodiments of the organic peroxide are available under the PERKADOX brand from AkzoNobel, such as grade BC-FF.

### Thermoplastic Elastomer Article

As described herein, the occurrence of silane crosslinking, along with the presence of the para-alkylstyrene produces a thermoplastic elastomer article having improved chemical resistance, heat resistance, and observable clarity.

In embodiments, the styrene block copolymer may be silane grafted and silane crosslinked. In embodiments, the at least one terminal polymer block A comprising a vinyl compound having para-alkylstyrene may be silane grafted and silane crosslinked. In embodiments, both terminal polymer blocks of the styrene block copolymer may be terminal polymer block A and both terminal blocks may be silane grafted and silane crosslinked. In embodiments, the styrene block copolymer may comprise terminal polymer blocks A and at least one interior polymer block B comprising conjugated diene, and both the terminal blocks and the at least one interior polymer block may be silane grafted and silane crosslinked. Having the terminal blocks and the at least one interior polymer block silane crosslinked may lead to increased crosslinking, which may improve the chemical and heat resistance of the thermoplastic elastomer article.

In embodiments, the thermoplastic elastomer article may have a compression set (125° C.) greater than or equal to 20%, greater than or equal to 23%, greater than or equal to 25%, or even greater than or equal to 27%. In embodiments, the thermoplastic elastomer article may have a compression set (125° C.) less than or equal to 45%, less than or equal to 43%, less than or equal to 40%, less than or equal to 37%, or even less than or equal to 35%. In embodiments, the thermoplastic elastomer article may have a compression set (125° C.) from 20% to 45%, from 20% to 43%, from 20% to 40%, from 20% to 37%, from 20% to 35%, from 23% to 45%, from 23% to 43%, from 23% to 40%, from 23% to 37%, from 23% to 35%, from 25% to 45%, from 25% to 43%, from 25% to 40%, from 25% to 37%, from 25% to 35%, from 27% to 45%, from 27% to 43%, from 27% to 40%, from 27% to 37%, or even from 27% to 35%, or any and all sub-ranges formed from any of these endpoints.

In embodiments, the thermoplastic elastomer article may have a Shore A hardness greater than or equal to 25, greater than or equal to 30, greater than or equal to 35, greater than or equal to 40, or even greater than or equal to 45. In embodiments, the thermoplastic elastomer article may have a Shore A hardness less than or equal to 80, less than or equal to 75, or even less than or equal to 70. In embodiments, the thermoplastic elastomer article may have a Shore A hardness from 25 to 80, from 25 to 75, from 25 to 70, from 30 to 80, from 30 to 75, from 30 to 70, from 35 to 80, from 35 to 75, from 35 to 70, from 40 to 80, from 40 to 75, from 40 to 70, from 45 to 80, from 45 to 75, or even from 45 to 70, or any and all sub-ranges formed from any of these endpoints.

In embodiments, the thermoplastic elastomer article may have a tensile strength at break greater than or equal to 1 MPa, greater than or equal to 2 MPa, or even greater than or equal to 3 MPa. In embodiments, the thermoplastic elastomer article may have a tensile strength at break less than or equal to 8 MPa, less than or equal to 7 MPa, or even less than or equal to 6 MPa. In embodiments, the thermoplastic elastomer article may have a tensile strength at break from 1 MPa to 8 MPa, from 1 MPa to 7 MPa, from 1 MPa to 6 MPa, from 2 MPa to 8 MPa, from 2 MPa to 7 MPa, from 2 MPa to 6 MPa, from 3 MPa to 8 MPa, from 3 MPa to 7 MPa, or even from 3 MPa to 6 MPa, or any and all sub-ranges formed from any of these endpoints.

In embodiments, the thermoplastic elastomer article may have a tensile elongation at break greater than or equal to 150%, greater than or equal to 175%, or even greater than or equal to 200%. In embodiments, the thermoplastic elastomer article may have a tensile elongation at break less than or equal to 400%, less than or equal to 350%, or even less than or equal to 300%. In embodiments, the thermoplastic elastomer article may have a tensile elongation at break from 150% to 400%, from 150% to 350%, from 150% to 300%, from 175% to 400%, from 175% to 350%, from 175% to 300%, from 200% to 400%, from 200% to 350%, or even from 200% to 300%, or any and all sub-ranges formed from any of these endpoints.

As exemplified in the Examples section below, the thermoplastic elastomer articles described herein comprising the crosslinked reaction product of styrene block copolymer and silane have improved chemical resistance, heat resistance, and observable clarity.

### Moisture Cure Catalyst

In embodiments, the thermoplastic elastomer article may comprise a moisture cure catalyst to initiate silane crosslinking of the styrene block copolymer such that the crosslinked reaction product is a moisture cure reaction product. With a moisture cure process, the process is relatively controlled and results in increased crosslinking, particularly at the at least one terminal polymer block A, as compared to a peroxide cure process.

In embodiments, the moisture cure catalyst may comprise organotin (e.g., dibutylin dilaurate), carboxylic acids, metal complex compounds (e.g., metal carboxylates), aluminum triacetyl acetonate, nickel tetraacetyl acetonate, chromium hexaacetyl acetonate, titanium tetraacetyl acetonate, and metal alkoxides (e.g., aluminum ethoxide, aluminum propoxide, titanium ethoxide, titanium propoxide), or a combination thereof.

In embodiments, the catalyst is blended with the styrene block copolymer and the silane during silane grafting. In other embodiments, the catalyst is added to the extruded formulation wherein the styrene block copolymer is silane grafted. The styrene block copolymer that is silane grafted will crosslink upon exposure to moisture (e.g., air).

### Polyolefin and Polyolefin Elastomer

In embodiments, the thermoplastic elastomer article may further comprise at least one of polyolefin and polyolefin elastomer to help improve the chemical and heat resistance of the thermoplastic elastomer article.

In embodiments, the polyolefin and/or the polyolefin elastomer is included in amounts greater than or equal to 1 wt %. In embodiments, the polyolefin and/or the polyolefin elastomer may be limited (e.g., less than or equal to 20 wt %) such that a reduced compression set (e.g., less than or equal to 45% at 125° C.) may be achieved. In embodiments, the amount of the polyolefin and/or the polyolefin elastomer in the thermoplastic elastomer article may be greater than or equal to 1 wt %, greater than or equal to 3 wt %, or even greater than or equal to 5 wt %, or even greater than or equal to 7 wt %. In embodiments, the amount of the polyolefin and/or the polyolefin elastomer in the thermoplastic elastomer article may be less than or equal to 20 wt %, less than or equal to 17 wt %, less than or equal to 15 wt %, less than or equal to 13 wt %, or even less than or equal to 10 wt %. In embodiments, the amount of the polyolefin and/or the polyolefin elastomer in the thermoplastic elastomer article may be from 1 wt % to 20 wt %, from 1 wt % to 17 wt %, from 1 wt % to 15 wt %, from 1 wt % to 13 wt %, from 1 wt % to 10 wt %, from 3 wt % to 20 wt %, from 3 wt % to 17 wt %, from 3 wt % to 15 wt %, from 3 wt % to 13 wt %, from 3 wt % to 10 wt %, from 5 wt % to 20 wt %, from 5 wt % to 17 wt %, from 5 wt % to 15 wt %, from 5 wt % to 13 wt %, from 5 wt % to 10 wt %, from 7 wt % to 20 wt %, from 7 wt % to 17 wt %, from 7 wt % to 15 wt %, from 7 wt % to 13 wt %, or even from 7 wt % to 10 wt %, or any and all sub-ranges formed form any of these endpoints.

In embodiments, the polyolefin may comprise polypropylene. In embodiments, the polypropylene may comprise a polypropylene homopolymer (i.e., composed of propylene monomers) or a polypropylene copolymer having greater than 50 wt % propylene monomer and an additional comonomer such as C₂ and C₄-C₁₂ alpha olefins.

In embodiments, the polypropylene may comprise a melt flow rate (230° C./2.16 kg) greater than or equal to 0.1 g/10 min, greater than or equal to 0.5 g/10 min, greater than or equal to 1 g/10 min or even greater than or equal to 3 g/10 min. In embodiments, the polypropylene may comprise a melt flow rate (230° C./2.16 kg) less than or equal to 10 g/10 min or even less than or equal to 5 g/10 min. In embodiments, the polypropylene may comprise a melt flow rate (230° C./2.16 kg) from 0.1 g/10 min to 10 g/10 min, from 0.1 g/10 min to 5 g/10 min, from 0.5 g/10 min to 10 g/10 min, from 0.5 g/10 min to 5 g/10 min, from 1 g/10 min to 10 g/10 min, from 1 g/10 min to 5 g/10 min, from 3 g/10 min to 10 g/10 min, or even from 3 g/10 min to 5 g/10 min, or any and all sub-ranges formed from any of these endpoints.

In embodiments, the polypropylene may comprise a density greater than or equal to 0.8 g/cm³ or even greater than or equal to 0.85 g/cm³. In embodiments, the polypropylene may comprise a density less than or equal to 1.10 g/cm³ or even less than or equal to 1.00 g/cm³. In embodiments, the polypropylene may comprise a density from 0.80 g/cm³ to 1.10 g/cm³, from 0.80 g/cm³ to 1.00 g/cm³, from 0.85 g/cm³ to 1.10 g/cm³, or even from 0.85 g/cm³ to 1.00 g/cm³, or any and all sub-ranges formed from any of these endpoints.

In embodiments, the polypropylene may comprise a tensile strength at yield greater than or equal to 25 MPa or even greater than or equal to 30 MPa. In embodiments, the polypropylene may comprise a tensile strength at yield less than or equal to 45 MPa or even less than or equal to 40 MPa. In embodiments, the polypropylene may comprise a tensile strength at yield from 25 MPa to 45 MPa, from 25 MPa, to 40 MPa, from 30 MPa to 45 MPa, or even from 30 MPa to 40 MPa, or any and all sub-ranges formed from any of these endpoints.

In embodiments, the polypropylene may comprise a tensile elongation at yield greater than or equal to 3% or even greater than or equal to 5%. In embodiments, the polypropylene may comprise a tensile elongation at yield less than or equal to 20% or even less than or equal to 15%. In embodiments, the polypropylene may comprise a tensile elongation at yield from 3% to 20%, from 3% to 15%, from 5% to 20%, or even from 5% to 15%, or any and all sub-ranges formed from any of these endpoints.

Suitable commercial embodiments of the polypropylene are available under the FORMOLENE brand from Formosa Plastics, such as polypropylene homopolymer grade 1102KR. Table 1 shows certain properties of FORMOLENE 1102KR.

TABLE 1

| | FORMOLENE 1102KR |
|---|---|
| Melt flow rate | 4 |
| (230° C./2.16 kg) (g/10 min) | |
| Density (g/cm³) | 0.9 |
| Tensile strength at yield (MPa) | 36 |
| Tensile elongation at yield (%) | 9 |

In embodiments, the polyolefin elastomer may comprise olefin block copolymer, ethylene alpha-olefin copolymer, or a combination thereof. In embodiments, the polyolefin elastomer may comprise olefin block copolymer. In embodiments, the polyolefin elastomer may comprise ethylene alpha-olefin copolymer. In embodiments, the polyolefin elastomer may comprise olefin block copolymer and ethylene alpha-olefin copolymer.

In embodiments, the olefin block copolymer may comprise an ethylene alpha-olefin repeating unit. The ethylene alpha-olefin repeating unit is the polymerized reaction product of ethylene and C₃-C₁₂ olefins. For example, in embodiments, the ethylene alpha-olefin repeating unit may comprise ethylene-octene copolymer, ethylene-hexene copolymer, ethylene-butene copolymer, or a combination thereof.

In embodiments, the olefin block copolymer may have a melt flow rate (190° C./2.16 kg) greater than or equal to 1 g/10 min or even greater than or equal to 5 g/10 min. In embodiments, the olefin block copolymer may have a melt flow rate (190° C./2.16 kg) less than or equal to 25 g/10 min or even less than or equal to 20 g/10 min. In embodiments, the olefin block copolymer may have a melt flow rate (190° C./2.16 kg) from 1 g/10 min to 25 g/10 min, from 1 g/10 min to 20 g/10 min, from 5 g/10 min to 25 g/10 min, or even from 5 g/10 min to 20 g/10 min, or any and all sub-ranges formed from any of these endpoints.

In embodiments, the olefin block copolymer may have a density greater than or equal to 0.80 g/cm³ or even greater than or equal to 0.85 g/cm³. In embodiments, the olefin block copolymer may have a density less than or equal to 0.95 g/cm³ or even less than or equal to 0.90 g/cm³. In embodiments, the olefin block copolymer may have a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the olefin block copolymer may have a tensile strength greater than or equal to 1 MPa or even greater than or equal to 5 MPa. In embodiments, the olefin block copolymer may have a tensile strength less than or equal to 15 MPa or even less than or equal to 10 MPa. In embodiments, the olefin block copolymer may have a tensile strength from 1 MPa to 15 MPa, from 1 MPa to 10 MPa, from 5 MPa to 15 MPa, or even from 5 MPa to 10 MPa, or any and all sub-ranges formed from any of these endpoints.

In embodiments, the olefin block copolymer may have a tensile elongation greater than or equal to 1250% or even greater than or equal to 1500%. In embodiments, the olefin block copolymer may comprise a tensile elongation less than or equal to 2000% or even less than or equal to 1750%. In embodiments, the olefin block copolymer may have a tensile elongation from 1250% to 2000%, from 1250% to 1750%, from 1500% to 2000%, or even from 1500% to 1750%, or any and all sub-ranges formed from any of these endpoints.

In embodiments, the olefin block copolymer may have a Shore A hardness greater than or equal to 50 or even greater than or equal to 60. In embodiments, the olefin block copolymer may have a Shore A hardness less than or equal to 85 or even less than or equal to 75. In embodiments, the olefin block copolymer may have a Shore A hardness from 50 to 85, from 50 to 75, from 60 to 85, or even from 60 to 75, or any and all sub-ranges formed from any of these endpoints.

Suitable commercial embodiments of olefin block copolymer are available under the Infuse brand, such as 9500 and 9817, from Dow Chemical Company.

The ethylene alpha-olefin copolymer is the polymerized reaction product of ethylene and C₃-C₁₂ olefins. For example, in embodiments, the ethylene alpha-olefin copolymer may comprise ethylene-octene copolymer, ethylene-hexene copolymer, ethylene-butene copolymer, or a combination thereof.

In embodiments, the ethylene-alpha olefin copolymer may have a melt flow rate (190° C./2.16 kg) greater than or equal to 0.1 g/10 min or even greater than or equal to 0.25 g/10 min. In embodiments, the ethylene-alpha olefin copolymer may have a melt flow rate (190° C./2.16 kg) less than or equal to 3 g/10 min or even less than or equal to 1 g/10 min. In embodiments, the ethylene-alpha olefin copolymer may have a melt flow rate (190° C./2.16 kg) from 0.1 g/10 min to 3 g/10 min, from 0.1 g/10 min to 1 g/10 min, from 0.25 g/10 min to 3 g/10 min, or even from 0.25 g/10 min to 1 g/10 min, or any and all sub-ranges formed from any of these endpoints.

In embodiments, the ethylene-alpha olefin copolymer may have a density greater than or equal to 0.80 g/cm³ or even greater than or equal to 0.85 g/cm³. In embodiments, the ethylene-alpha olefin copolymer may have a density less than or equal to 0.95 g/cm³ or even less than or equal to 0.90 g/cm³. In embodiments, the ethylene-alpha olefin copolymer may have a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the ethylene-alpha olefin copolymer may have a Mooney viscosity (ML 1+4, 121° C.) greater than or equal to 20, greater than or equal to 30, or even greater than or equal to 40. In embodiments, the ethylene-alpha olefin copolymer may have a Mooney viscosity (ML 1+4, 121° C.) less than or equal to 70, less than or equal to 60, or even less than or equal to 50. In embodiments, the ethylene-alpha olefin copolymer may have a Mooney viscosity (ML 1+4, 121° C.) from 20 to 70, from 20 to 60, from 20 to 50, from 30 to 70, from 30 to 60, from 30 to 50, from 40 to 70, from 40 to 60, or even from 40 to 50, or any and all sub-ranges formed from any of these endpoints.

In embodiments, the ethylene-alpha olefin copolymer may have a tensile strength greater than or equal to 1 MPa or even greater than or equal to 2 MPa. In embodiments, the ethylene-alpha olefin copolymer may have a tensile strength less than or equal to 10 MPa or even less than or equal to 5 MPa. In embodiments, the ethylene-alpha olefin copolymer may have a tensile strength from 1 MPa to 10 MPa, from 1 MPa to 5 MPa, from 2 MPa to 10 MPa, or even from 2 MPa to 5 MPa, or any and all sub-ranges formed from any of these endpoints.

In embodiments, the ethylene-alpha olefin copolymer may have a tensile elongation greater than or equal to 750% or even greater than or equal to 1000%. In embodiments, the ethylene-alpha olefin copolymer may comprise a tensile elongation less than or equal to 1750% or even less than or equal to 1500%. In embodiments, the ethylene-alpha olefin copolymer may have a tensile elongation from 750% to 1750%, from 750% to 1500%, from 1000% to 1750%, or even from 1000% to 1500%, or any and all sub-ranges formed from any of these endpoints.

In embodiments, the ethylene-alpha olefin copolymer may have a Shore A hardness greater than or equal to 40 or even greater than or equal to 45. In embodiments, the ethylene-alpha olefin copolymer may have a Shore A hardness less than or equal to 60 or even less than or equal to 65. In embodiments, the ethylene-alpha olefin copolymer may have a Shore A hardness from 40 to 60, from 40 to 55, from 45 to 60, or even from 45 to 55, or any and all sub-ranges formed from any of these endpoints.

Suitable commercial embodiments of the ethylene-alpha olefin copolymer are available under the Engage brand, such as XLT 8677, from Dow Chemical Company.

### Plasticizer

In embodiments, the thermoplastic elastomer articles described herein may further comprise such that to reduce hardness and improve flow.

In embodiments, the plasticizer may comprise non-polar plasticizer (e.g., mineral oil).

In embodiments, the amount of the plasticizer in the thermoplastic elastomer article may be greater than or equal to 15 wt %, greater than or equal to 20 wt %, greater than or equal to 25 wt %, greater than or equal to 30 wt %, greater than or equal to 35 wt %, or even greater than or equal to 40 wt %. In embodiments, the amount of the plasticizer in the thermoplastic elastomer article may be less than or equal to 65 wt %, less than or equal to 60 wt %, less than or equal to 55 wt %, or even less than or equal to 50 wt %. In embodiments, the amount of the plasticizer in the thermoplastic elastomer article may be from 15 wt % to 65 wt %, from 15 wt % to 60 wt %, from 15 wt % to 55 wt %, from 15 wt % to 50 wt %, from 20 wt % to 65 wt %, from 20 wt % to 60 wt %, from 20 wt % to 55 wt %, from 20 wt % to 50 wt %, from 25 wt % to 65 wt %, from 25 wt % to 60 wt %, from 25 wt % to 55 wt %, from 25 wt % to 50 wt %, from 30 wt % to 65 wt %, from 30 wt % to 60 wt %, from 30 wt % to 55 wt %, from 30 wt % to 50 wt %, from 35 wt % to 65 wt %, from 35 wt % to 60 wt %, from 35 wt % to 55 wt %, from 35 wt % to 50 wt %, from 40 wt % to 65 wt %, from 40 wt % to 60 wt %, from 40 wt % to 55 wt %, or even from 40 wt % to 50 wt %, or any and all sub-ranges formed from any of these endpoints.

Suitable commercial embodiments of the plasticizer are available under the PURETOL brand from Petro-Canada, such as grade PSO 380.

### Additive

In embodiments, the thermoplastic elastomer article may further comprise an additive. In embodiments, the additive may comprise adhesion promoters; biocides; anti-fogging agents; anti-static agents; blowing and foaming agents; bonding agents and bonding polymers; polar copolymers (e.g., ethylene-vinyl acetate (EVA), ethylene butyl acrylate (EBA), or ethyl methacrylate (EMA)); dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; or combinations thereof.

### Processing

In embodiments, the thermoplastic elastomer article described herein may be made with a batch process or continuous process.

In embodiments, the components of the thermoplastic elastomer article, including the styrene block copolymer may be added to an extruder (27 MM Leistriz Twin Extruder (L/D 52)) and blended. In embodiments, silane is added to the blend such that the styrene block copolymer is silane grafted. In embodiments, the blending (e.g., in the barrel of the extruder) may be carried out at a temperature from 150° C. to 220° C.

Blending (also known as compounding) devices are well known to those skilled in the art and generally include feed means, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die.

In embodiments, the shaped, silane-grafted blend may be cured such that the styrene block copolymer is silane crosslinked. In embodiments, a moisture cure catalyst may be added to initiate silane crosslinking of the styrene block copolymer. In embodiments, the catalyst is blended with the styrene block copolymer and the silane during silane grafting. In other embodiments, the catalyst is added at the extrusion step.

### Examples

Table 2 below shows sources of ingredients used to form the thermoplastic elastomer articles of Comparative Examples C₁ to C₇ and Examples E1 to E5.

TABLE 2

| Ingredients | Brand | Source |
|---|---|---|
| polypropylene | FORMOLENE | Formosa Plastics |
| | 1102KR | |
| para-methylstyrene | SEPTON | Kuraray |
| block copolymer | V9461 | |
| ethylene propylene | NORDEL IP | Dow Chemicals |
| diene rubber | 4785HM | |
| styrene-ethylene-butylene- | KRATON | Kraton Polymers |
| styrene (SEBS) | G1641 | |
| mineral oil (plasticizer) | PURETOL | Petro-Canada |
| | PSO 380 | |
| vinyltrimethoxy silane | SILQUEST | Momentive |
| | A-171 | |
| dicumyl peroxide | PERKADOX | AkzoNobel |
| | BC-FF | |
| organic peroxide | VAROX 802 | Vanderbilt Chemicals |
| | SP-40MB | |
| triallyl cyanurate | SR 507 | Arkema |
| triallyl isocyanurate | SR 533 | Arkema |
| trimethylolpropane | SR 351 | Arkema |
| triacrylate | | |

Table 3 below shows the formulations used to form and the certain properties of Comparative Examples C₁ to C₇ and Examples E1 to E5.

To prepare comparative and exemplary thermoplastic elastomer plaques for Comparative Examples C₁ to C₇ and Examples E1 to E5, the components of the formulations listed in Table 3 were added into a 27 MM Leistriz Twin Extruder (L/D/52) and blended at barrel temperature of 193° c. and a rate of 5 rotations per second. The mixed formulations were extruded at a speed of 5 g/s.

The extruded formulations for Comparative Examples C1 and C2 and Examples E1 to E5 were blended with 3% tin catalyst master match (MB). MB has a polyether carrier with 1.5% dibutylin dilaurate (MARK 1038, Galata Chemicals).

The blended formulations for Comparative Examples C₁ to C₇ and E1 and E5 were injection molded (i.e., shaped) to form plaques. The plaques were conditioned at 90° C. and 90% relative humidity for 24 hours prior to measuring the properties listed in Table 3.

To measure the “oil immersion weight increase” listed in Table 3, the plaques having a diameter of 39 mm and a thickness of 3 mm were weighed and then immersed in IRM 903 oil for 3 days at 125 TC. After immersion, the plaques were weighed and the weight percentage increases were calculated.

TABLE 3

| | Example | | | |
|---|---|---|---|---|
| | C1 | | C2 | |
| Ingredient | pt | % | pt | % |
| FORMOLENE 1102KR | 45.00 | 18.04 | 25.00 | 10.83 |
| NORDEL IP 4785HM | 100.00 | 40.08 | — | — |
| KRATON G1641 | — | — | 100.00 | 43.31 |
| PURETOL PSO 380 | 100.00 | 40.08 | 100.00 | 43.31 |
| SILQUEST A-171 | 3.96 | 1.59 | 4.97 | 2.15 |
| PERKADOX BC-FF | 0.53 | 0.21 | 0.90 | 0.39 |
| Total | 249.49 | 100.00 | 230.87 | 100.00 |
| Hardness (Shore A) | 66 | | 27 | |
| Tensile strength at break (MPa) | 4.69 | | 2.28 | |
| Tensile elongation at break (%) | 280 | | 300 | |
| Oil immersion weight | 103 | | 140 | |
| increase (125° C./3 days, %) | | | | |
| Compression set (125° C./22 hr, %) | 44 | | 43 | |
| Observable clarity | opaque | | translucent | |
| | Example | | | |
| | E1 | | E2 | |
| Ingredient | pt | % | pt | % |
| FORMOLENE 1102KR | 25.00 | 10.86 | 35.00 | 14.56 |
| SEPTON V9461 | 100.00 | 43.46 | 100.00 | 41.60 |
| PURETOL PSO 380 | 100.00 | 43.46 | 100.00 | 41.60 |
| SILQUEST A-171 | 4.25 | 1.85 | 4.51 | 1.88 |
| PERKADOX BC-FF | 0.85 | 0.37 | 0.90 | 0.37 |
| Total | 230.10 | 100.00 | 240.41 | 100.00 |

| | | |
|---|---|---|
| Hardness (Shore A) | 53 | 63 |
| Tensile strength at break (MPa) | 5.03 | 5.65 |
| Tensile elongation at break (%) | 300 | 270 |
| Oil immersion weight | 94 | 83 |
| increase (125° C./3 days, %) | | |
| Compression set (125° C./22 hr, %) | 31 | 32 |
| Observable clarity | translucent | translucent |

| | Example | | | | | |
|---|---|---|---|---|---|---|
| | E3 | | E4 | | E5 | |
| Ingredient | pt | % | pt | % | pt | % |
| FORMOLENE 1102KR | 25.00 | 9.98 | 15.00 | 6.25 | 15.00 | 5.35 |
| SEPTON V9461 | 100.00 | 39.93 | 100.00 | 41.65 | 100.00 | 35.70 |
| NORDEL IP 4785HM | — | — | — | — | — | — |
| KRATON G1641 | — | — | — | — | — | — |
| PURETOL PSO 380 | 120.00 | 47.91 | 120.00 | 49.98 | 160.00 | 57.12 |
| SILQUEST A-171 | 4.60 | 1.84 | 4.32 | 1.80 | 4.32 | 1.54 |
| PERKADOX BC-FF | 0.85 | 0.34 | 0.80 | 0.33 | 0.80 | 0.29 |
| Total | 250.45 | 100.00 | 240.12 | 100.00 | 280.12 | 100.00 |
| Hardness (Shore A) | 46 | | 39 | | 32 | |
| Tensile strength at break (MPa) | 4.00 | | 2.90 | | 2.34 | |
| Tensile elongation at break (%) | 250 | | 210 | | 230 | |
| Oil immersion weight | 89 | | 99 | | 90 | |
| increase (125° C./3 days, %) | | | | | | |
| Compression set (125° C./22 hr, %) | 31 | | 27 | | 27 | |
| Observable clarity | translucent | | translucent | | translucent | |
| | Example | | | | | |
| | C3 | | C4 | | C5 | |
| Ingredient | pt | % | pt | % | pt | % |
| FORMOLENE 1102KR | 25.00 | 10.82 | 25.00 | 10.73 | 25.00 | 10.64 |
| SEPTON V9461 | 100.00 | 43.29 | 100.00 | 42.92 | 100.00 | 42.55 |
| PURETOL PSO 380 | 100.00 | 43.29 | 100.00 | 42.92 | 100.00 | 42.55 |
| VAROX 802 SP-40MB | 2.00 | 0.87 | 4.00 | 1.72 | 6.00 | 2.55 |
| SR 507 | 4.00 | 1.73 | 4.00 | 1.72 | 4.00 | 1.70 |
| SR 533 | — | — | — | — | — | — |
| SR 351 | — | — | — | — | — | — |
| Total | 231.00 | 100.00 | 233.00 | 100.00 | 235.00 | 100.00 |

| | | | |
|---|---|---|---|
| Hardness (Shore A) | 53 | 52 | 52 |
| Tensile strength at break (MPa) | 5.03 | 4.00 | 3.17 |
| Tensile elongation at break (%) | 410 | 260 | 200 |
| Oil immersion weight | — | — | — |
| increase (125° C./3 days, %) | | | |
| Compression set (125° C./22 hr, %) | 55 | 48 | 48 |
| Observable clarity | translucent | translucent | translucent |

| | Example | | | |
|---|---|---|---|---|
| | C6 | | C7 | |
| Ingredient | pt | % | pt | % |
| FORMOLENE 1102KR | 25.00 | 10.59 | 25.00 | 10.59 |
| SEPTON V9461 | 100.00 | 42.37 | 100.00 | 42.37 |
| PURETOL PSO 380 | 100.00 | 42.37 | 100.00 | 42.37 |
| VAROX 802 SP-40MB | 3.00 | 1.27 | 3.00 | 1.27 |
| SR 507 | — | — | — | — |
| SR 533 | 8.00 | 3.39 | — | — |
| SR 351 | — | — | 8.00 | 3.39 |
| Total | 236.00 | 100.00 | 236.00 | 100.00 |

| | | |
|---|---|---|
| Hardness (Shore A) | 52 | 51 |
| Tensile strength at break (MPa) | 4.00 | 4.96 |
| Tensile elongation at break (%) | 270 | 560 |
| Oil immersion weight | — | — |
| increase (125° C./3 days, %) | | |
| Compression set (125° C./22 hr, %) | 49 | 56 |
| Observable clarity | translucent | translucent |

As shown in Table 3, Example E2, a thermoplastic elastomer article including para-methylstyrene block copolymer (SEPTON V9461) showed a reduced oil immersion increase, a reduced compression set, and improved observable clarity as compared to Comparative Example C1, a thermoplastic elastomer article of similar hardness including rubber (NORDEL IP 4785HM) without SEPTON V9461.

As also shown in Table 3, Example E5, a thermoplastic elastomer article including para-methylstyrene block copolymer (SEPTON V9461) showed a reduced oil immersion increase, a reduced compression set, and an improved observable clarity as compared to Comparative Example C2, a thermoplastic elastomer article of similar hardness including SEBS (KRATON G1641) without SEPTON V9461.

As indicated by Comparative Examples C1 and C2 and Examples E2 and E5, including para-methylstyrene block copolymer results in a thermoplastic elastomer article having improved chemical resistance, heat resistance, and observable clarity as compared to a thermoplastic elastomer article that does not include para-methylstyrene block copolymer.

As further shown in Table 3, Examples E1 to E5 including SEPTON V9461 crosslinked via a moisture cure process had a reduced compression set as compared to Comparative Examples C3 to C7, thermoplastic elastomer articles including SEPTON V9461 crosslinked via a peroxide cure process.

As indicated by Comparative Examples C₃ to C₇ and Examples E1 to E5, including para-methyl styrene block copolymer crosslinked via a moisture cure process has increased crosslinking as compared to a thermoplastic elastomer article that includes para-methylstyrene block copolymer crosslinked via a peroxide cure process.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A thermoplastic elastomer article comprising a crosslinked reaction product of:
styrene block copolymer, the styrene block copolymer comprising at least one terminal polymer block A, the at least one terminal polymer block A comprising a vinyl compound having para-alkylstyrene; and
silane;
wherein the styrene block copolymer is silane grafted and silane crosslinked.

2. The thermoplastic elastomer article of claim 1, wherein the para-alkylstyrene comprises para-methylstyrene.

3. The thermoplastic elastomer article of claim 1, wherein the crosslinked reaction product comprises a moisture cure reaction product.

4. The thermoplastic elastomer article of claim 1, wherein the at least one terminal polymer block A is silane grafted and silane crosslinked.

5. The thermoplastic elastomer article of claim 1, wherein the thermoplastic elastomer article comprises 20 wt % to 60 wt % of the styrene block copolymer, 23 wt % to 57 wt % of the styrene block copolymer, or 25 wt % to 55 wt % of the styrene block copolymer.

6. The thermoplastic elastomer article of claim 1, wherein the thermoplastic elastomer article comprises 0.5 wt % to 5 wt % of the silane.

7. The thermoplastic elastomer of claim 1, wherein the silane comprises vinyl trimethoxysilane, vinyl triethoxysilane, or a combination thereof

8. The thermoplastic elastomer article of claim 1, wherein the silane is included in a solution comprising organic peroxide.

9. The thermoplastic elastomer article of claim 8, wherein the organic peroxide comprises dicumyl peroxide.

10. The thermoplastic elastomer article of any one of c claim 1, wherein the thermoplastic elastomer article further comprises at least one of polyolefin and polyolefin elastomer.

11. The thermoplastic elastomer article of claim 10, wherein the thermoplastic elastomer article comprises 1 wt % to 20 wt % of the at least one of the polyolefin and the polyolefin elastomer, or 3 wt % to 17 wt % of the at least one of the polyolefin and the polyolefin elastomer, or 5 wt % to 15 wt % of the at least one of polyolefin and the polyolefin elastomer.

12. The thermoplastic elastomer of claim 10, wherein the polyolefin comprises polypropylene.

13. The thermoplastic elastomer of claim 10, wherein the polyolefin elastomer comprises olefin block copolymer, ethylene alpha-olefin copolymer, or a combination thereof.

14. The thermoplastic elastomer article of claim 1, wherein the thermoplastic elastomer article further comprises plasticizer.

15. The thermoplastic elastomer article of claim 14, wherein the thermoplastic elastomer article comprises 15 wt % to 65 wt % of the plasticizer, or 20 wt % to 63 wt % of the plasticizer, or 25 wt % to 60 wt % of the plasticizer.

16. The thermoplastic elastomer article of claim 14, wherein the plasticizer comprises mineral oil.

17. The thermoplastic elastomer article of claim 1, wherein the thermoplastic elastomer article comprises a compression set (125° C.) less than or equal to 45%.

18. A process for making a thermoplastic elastomer article comprising a crosslinked reaction product of styrene block copolymer and silane, the styrene block copolymer comprising at least one terminal polymer block A, the at least one terminal polymer block A comprising a vinyl compound having para-alkylstyrene, the process comprising the steps of:
grafting the styrene block copolymer with silane such that the styrene block copolymer is silane grafted;
shaping the silane-grafted blend; and
curing the shaped, silane-grafted blend such that the styrene block copolymer is silane crosslinked.

19. The process of claim 18, wherein the silane is included in a solution comprising organic peroxide.

20. The process of claim 18, wherein the process further includes adding a moisture cure catalyst, the moisture cure catalyst comprising organotin, carboxylic acids, metal complex compounds, aluminum triacetyl acetonate, nickel tetraacetyl acetonate, chromium hexaacetyl acetonate, titanium tetraacetyl acetonate, and metal alkoxides.
